(19) United States
(12) Patent Application Publication
(10) Pub. No.: US 2021/0107016 A1
(43) Pub. Date: Apr. 15, 2021

(54) SHOWERHEAD

(71) Applicant: ELIE LEVY, CAESAREA (IL)

(72) Inventor: ELIE LEVY, CAESAREA (IL)

(21) Appl. No.: 17/089,841

(22) Filed: Nov. 5, 2020

Related U.S. Application Data
(63) Continuation-in-part of application No. PCT/IL2019/050729, filed on Jun. 30, 2019.

(30) Foreign Application Priority Data
Jul. 12, 2018 (IL) 260563

(51) Int. Cl. B05B 1/18; A47K 7/02

(52) U.S. Cl. CPC B05B 1/185; A47K 7/028

(57) ABSTRACT

An edge that can be rotated manually 360 degrees so as to change the angle of scratching, as desired. The product also includes an elongated handle that facilitates physical access to every spot on the back and body.

### CROSS-REFERENCE TO RELATED APPLICATIONS

This application claims the benefit of priority from IL application No. 260563, the disclosure of which is included and incorporated herein by reference.

### BRIEF DESCRIPTION OF THE DRAWINGS

FIG. 1 is a perspective view of my showerhead.

FIG. 2 is a front view of my showerhead.

FIG. 3 is a side view of my showerhead.

FIG. 4 is a top view of my showerhead.

FIG. 5 is a rear right view of my showerhead.

FIG. 6 is a rear left view of my showerhead.

FIG. 7 is a front rotated view of my showerhead.

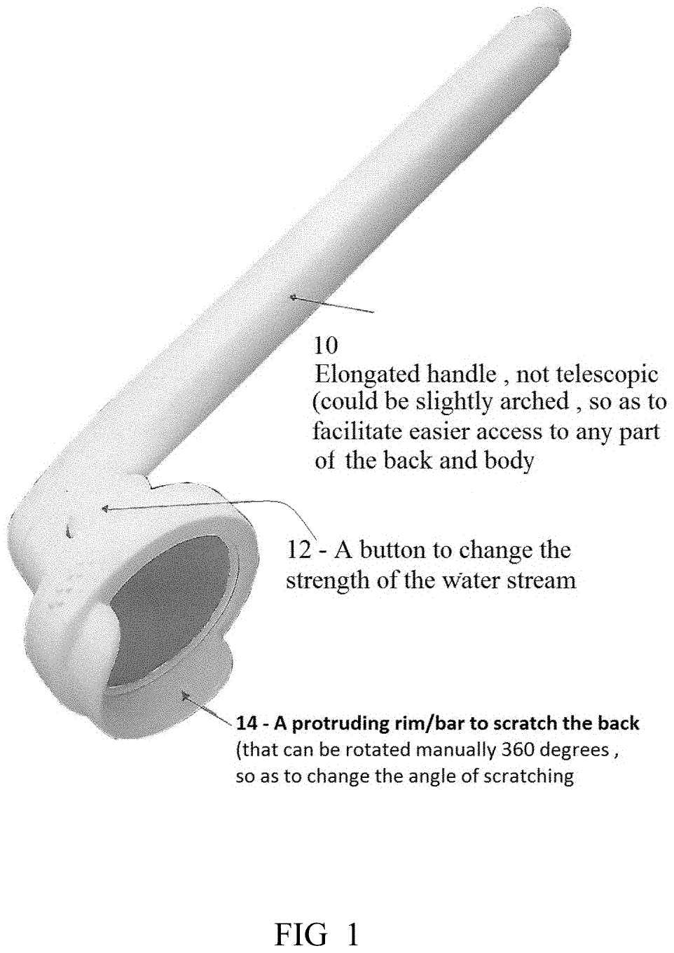

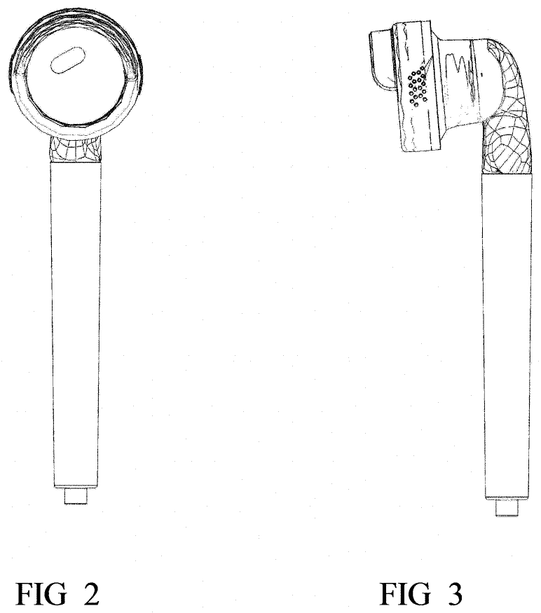

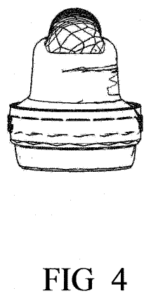

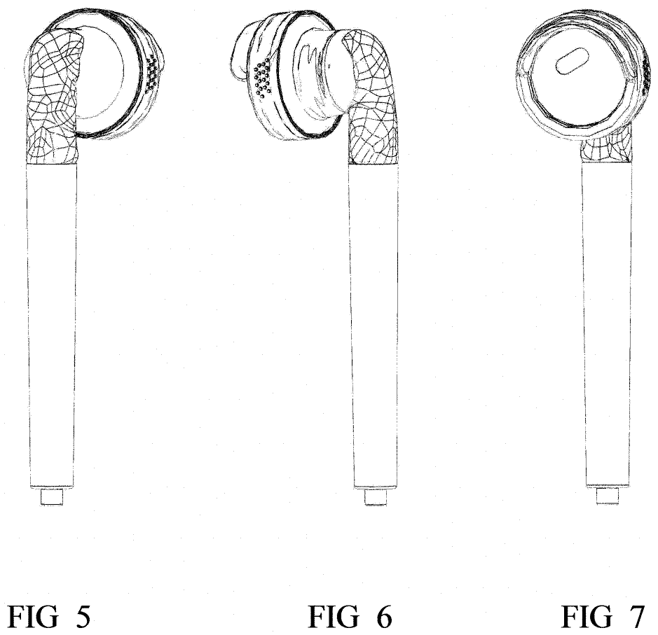

### DETAILED DESCRIPTION

My idea comes to me every time I take a shower.

Often, I long to scratch my back and I think: if only the hand held showerhead I was using was a little bit longer, and if it had at its head a protruding edge or rim, I could scratch every spot on my back, as I cannot do it now with my bare hands or nails.

This is all the idea, simple but efficient.

Of course, there are on the market special brushes and/or other accessories that can do the job, but it is not so convenient, because you have to turn off the water, switch from the hand held showerhead to the other accessory, wet it if this is possible, scratch your back, then clean the accessory with water, put it back in place, take the hand held showerhead again (or turn-on the head shower), whereas all these operations can be done only by one simple accessory that you already are using.

You can use the improved hand showerhead, either wet or dry to scratch your back with pleasure with this improved hand held showerhead, as explained above.

Reference signs in the figures: 10: handle; 12: button; 14: bar.

What is claimed is:

1. The main claims of the idea and/or concept and or/invention is as follows:
a) Concept methodology
Innovative and original method for structure and configuration of a handheld showerhead for the shower/bathtub
Innovative and original method for a scratching/scrubbing cleaning edge located on the showerhead
b) Technology
An edge that can scratch/scrub/clean the back
An edge that can be rotated manually 360° so as to change the angle of scratching, as desired
The product also includes an elongated handle that facilitates physical access to every spot on the back and body.
